(19) United States
(12) Patent Application Publication
(10) Pub. No.: US 2024/0086505 A1
(43) Pub. Date: Mar. 14, 2024

(54) CONTROL OF ACCESS TO THE EQUIPMENT OF A SITE SECURED BY BIOMETRIC AUTHENTICATION

(71) Applicant: ATOS SE, Bezons (FR)

(72) Inventors: Eric FIEVEZ, Suresnes (FR); Steve PEGUET, Choisy Le Roi (FR); Bruno Moret, Nanterre (FR)

(21) Appl. No.: 15/545,983

(22) PCT Filed: Jan. 20, 2016
(86) PCT No.: PCT/FR2016/050109

§ 371 Date: Jan. 4, 2023

(30) Foreign Application Priority Data
Jan. 22, 2015 (FR) 1550503

(51) Int. Cl. G06F 21/32

(52) U.S. Cl. CPC G06F 21/32

(57) ABSTRACT

Some embodiments are related to a system for controlling access of a user to a set of equipment of a secure site, including: a communicating portable device associated with the user and containing an identifier of the latter, a biometric activator allowing the opening of a temporary session for the user by means of a biometric authentication, the user being identified by his communicating portable device, and in which the equipment is adapted so as to be usable only in the event of authorization of access by the user after verification of the opening of the temporary session; the user being identified by the equipment by virtue of his communicating portable device.

### CROSS REFERENCE TO RELATED APPLICATION(S)

This application is a national phase filing under 35 C.F.R. § 371 of and claims priority to PCT Patent Application No. PCT/FR2016/050109, filed on Jan. 20, 2016, which claims the priority benefit under 35 U.S.C. § 119 of French Patent Application No. 1550503, filed on Jan. 22, 2015, the contents of each of which are hereby incorporated in their entireties by reference.

### BACKGROUND

Some embodiments are related to the control of access to the equipment of a secure site, such as a factory, laboratory or any other place where the need exists to control the physical or logical access by the personnel present to the different equipment. They apply in particular to the control of access to equipment connected to a communication network associated with the secure site.

Some sites may require the implementation of secure access to the different equipment which is present there. This applies, in particular, to industrial sites in which equipment such as machinery, valves, electrical control panels, computer terminals, etc. may be handled by authorized personnel only. The same may apply to doors authorizing or preventing access to certain areas of the secure site. The secure site may also be a non-industrial site: it may be an administrative site, a hospital, etc.

It is customary to supply personnel with communicating portable devices such as badges which, through communication with the equipment, permit or prevent access by the badge wearer to this equipment. The communication may take place using technologies such as RFID (“Radio Frequency Identification”) or NFC (“Near Field Communication”).

However, a solution of this type is inadequate when a high level of security may be required. In fact, portable devices of this type may be loaned between personnel members or may be lost, stolen, etc., in such a way that there is no guarantee that the bearer of a device of this type is actually an authorized personnel member.

An alternative solution can include or can consist of using biometric authentication means. These ensure that the user of equipment associated with these means is actually an authorized personnel member. However, a solution of this type may require the deployment of these biometric authentication means on all or most of the equipment subject to authorization. These means are costly and a deployment of this type incurs a prohibitive cost when the site includes a large number of items of equipment to be secured.

Moreover, solutions based on an interaction, in particular via a keypad, have been proposed. They may can include or can consist of the input of an identifier and a password, for example. These solutions suffer from the fact that they may require a human interaction which may prove to be too slow or too dependent on a network access. Complex interactions are detrimental to the efficiency of site personnel, but are also highly disadvantageous or even unviable in the event of an emergency. Moreover, if a situation may require an urgent intervention, personnel risk being in a stressful situation so that they will not necessarily be capable of performing these authentication interactions in a correct manner.

Moreover, on an industrial site, personnel may need to wear gloves, special goggles, etc., so that it is not easy, or may even be difficult, for them to handle a keypad or other interaction devices for their authentication.

The wearing of gloves or a mask may furthermore prevent the implementation of solutions based on biometric authentication.

### SUMMARY

Some embodiments provide a solution overcoming at least partially the aforementioned disadvantages.

For this purpose, some embodiments propose a method for controlling the access of a user to a set of equipment on a secure site, the user being associated with a communicating portable device containing an identifier, the method including the steps of:
Opening of a temporary session by a biometric activator for the user by means of a biometric authentication of the user;
Authorization of the access by the user to equipment of the set, following verification of the opening of the temporary session; the user being identified by the equipment by means of the communicating portable device.

Some embodiments include one or more of the following characteristics, which may be used separately or in partial combination with one another, or in full combination with one another:
the biometric authentication is carried out by means of an interaction with the biometric activator;
the equipment and the biometric activator are connected via a private communication network;
the data of the temporary session are stored on an access control server and the equipment access the access control server to allow the access authorization of the user;
the equipment stores the temporary session data of the user in a local memory for use during a subsequent access authorization for the user;
the communicating portable device communicates with the biometric activator and with the equipment via a wireless communication means, such as RFID, NFC, etc.;
the communicating portable device initiates the closure of the temporary session in the event of a break in the physical association between the user and the communicating portable device;
the communicating portable device carries out the biometric authentication by means of an internal sensor.

A different aspect of some embodiments relate to a system for controlling the access of a user to a set of equipment of a secure site, including:
a communicating portable device associated with the user and containing an identifier of the user,
a biometric activator allowing the opening of a temporary session for the user by means of a biometric authentication of the user, identified by the communicating portable device,
and in which the equipment is suitable for being usable only in the event of authorization of the access by the user following verification of the opening of the temporary session;
the user being identified by the equipment by means of the communicating portable device.

According to some embodiments, this system may furthermore include a private communication network connecting the biometric activator and the equipment, and an access control server also connected to the private communication network and storing the data of the temporary session.

Other characteristics and advantages of some embodiments will become evident from a reading of the description of some advantageous or preferred embodiments, given by way of example and with reference to the attached drawings.

### BRIEF DESCRIPTION OF THE DRAWINGS

FIG. 1 shows schematically an example embodiment of some embodiments on a particular secure site.

### DETAILED DESCRIPTION OF THE EMBODIMENTS

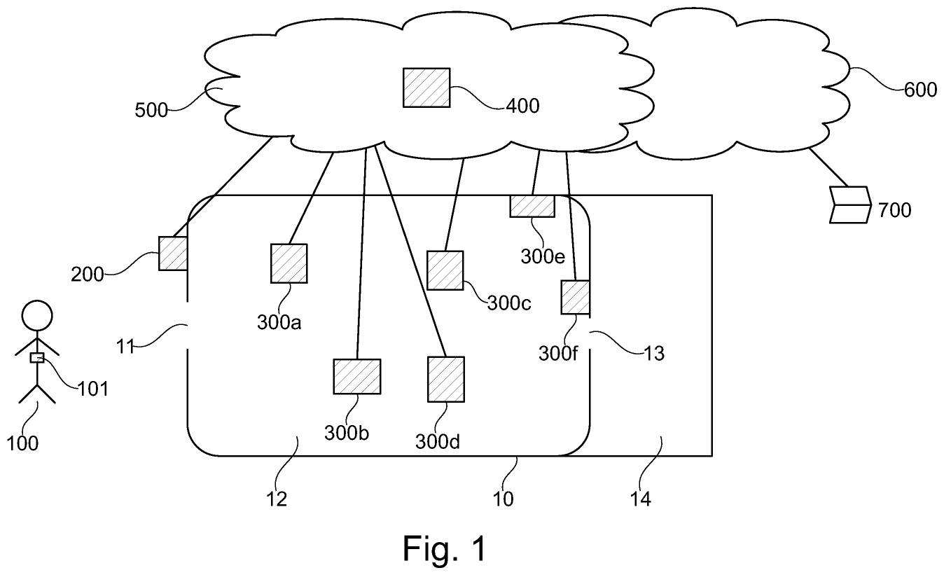

FIG. 1 shows a secure site in which some embodiments are capable of being implemented. This secure site 10 includes a set of equipment 300a, 300b, 300c, 300d, 300e, 300f. This equipment may be of different types.

On an industrial site, some of this equipment 300a, 300b, 300c, 300d may be industrial devices or tools: valves, machine tool control panels, etc. Others may include a general control panel 300e enabling control of a sector or the entirety of the industrial site 10. A different type of equipment may be a device 300f controlling a door 13. This door 13 may divide the site 10 into a normal security part 12 and a reinforced security part 14 controlled by this door 13 and the control device 300f.

A further type of equipment may be a computer, a digital tablet or any other terminal enabling connection to the private communication network 500 of the site and/or permitting access to databases or other remote equipment.

Some embodiments may also be applied to sites which are non-industrial, but may require a high degree of security of access to equipment.

The user 100, for example a member of the personnel of the site 10, wishing to enter the site 10 must in this embodiment first open a temporary session allowing him to access the equipment 300a . . . 300f, of the site. This session opening may take place with each entry onto the site for one working day, or at the start of each work cycle, or according to any other arrangements put in place by a site manager. A work cycle may correspond to a half day, for example, the day being divided by a lunch break.

This temporary session is opened by means of a biometric authentication of the user. This authentication may be implemented by using different types of biometric parameters: recognition of a fingerprint, the iris, voice, face, vein pattern of the palm of the hand, etc. According to one particular embodiment, a plurality of these biometric parameters can be used simultaneously.

This temporary session opening is performed by a biometric activator 200.

According to one embodiment, an interaction is implemented between the biometric activator and the user 100 for the biometric authentication. In particular, the biometric activator has means to perform the biometric authentication according to the chosen biometric parameter(s):
It may include a video camera or still camera, and also digital processing means to perform a recognition of the face, iris, etc.
It may include specific means and the digital processing means to perform a recognition of a fingerprint or of the venous pattern of the palm of the hand, etc.

The digital processing means are typically software means run on a digital processing platform. They may conform to the related art solutions accessible to the person of ordinary skill in the art. They may include the comparison with a digital fingerprint, generated from a raw datum originating from the acquisition of a biometric parameter by the digital activator (photo, etc.).

The digital fingerprints of the personnel authorized on the site 10 may be stored either in a site database or on a communicating portable device (card, token, bracelet or other) with which each member of the personnel is equipped. The use of a communicating portable device allows each member of the personnel to have his biometric fingerprint alone with him and avoids the use of a centralized biometric fingerprint database.

The database may be located remotely on an access control server 400 accessible to the biometric activator 200 via a private communication network 500. Alternatively, this database may be stored locally on this biometric activator 200.

The private communication network 500 may implement additional security mechanisms, but one advantage of some embodiments can include or can consist of the possibility of using a non-secure private communication network. This private communication network 500 may thus be part of the Internet network.

The equipment 300a . . . 300f and the biometric activator 200 may be connected via the private communication network 500 as shown in FIG. 1. It may also have a direct link via a secure protocol.

Furthermore, the user 100 is associated with a communicating portable device 101. This communicating portable device may be any electronic device suitable for being carried by the user 100 in a practical manner and capable of communicating with the biometric activator 200 and the equipment 300. It may be a badge, token, bracelet, etc., or a device capable of being integrated into an item of clothing (belt, vest, etc.), particularly in the case where the user must or should wear a specific item of clothing in order to enter the site 10. Multiple implementations are conceivable for this communicating portable device.

The means for communication between this device and the biometric activator and, as will be seen below, with the equipment, are preferably wireless communication means.

RFID (“Radio Frequency Identification”) technology, for example, may be used. This technology allows the radio identification of communicating portable devices of the “radio tag” type by storing information (in particular an identifier, but possibly other complementary data) and its transmission in response to a prompt from a reader. The biometric activator 200 may include a reader of this type in order to read the information stored in the communicating portable device 101. This information includes an identifier associated with the user 100.

Another possible technology is Near-Field Communication (NFC). This is a short-range, high-frequency wireless communication technology allowing the exchange of information between two devices. The biometric activator 200 and the communicating portable device 101 can thus enter into communication when they are sufficiently close, so that the identifier of the user 100 can be transmitted to the biometric activator.

The biometric terminal can thus recognize both the user authenticated by the biometric authentication means and an identifier of the user transmitted by the communicating portable device. A check can be carried out to ensure that the communicating portable device actually belongs to the authenticated person in order to prevent a person from validating the device of a colleague, for example, as well as some types of malicious intrusion.

If the user is authenticated as a member authorized on the site 10, his portable communicating device is activated. This activation corresponds to an opening of a temporary session for this user.

The session is temporary since the user 100 is authorized to use the equipment of the site 10 during a limited period only, at the end of which the session is closed. In other words, the communicating portable device 101 is activated for this limited period only.

This period may be predetermined, for example according to the duration of one work cycle, one day, etc. It may be shorter, requiring users to open a new session regularly in order to increase security of access to the site 10. Different embodiments are possible, according to the type of site 10 and the access management policy that is to be implemented.

The activation of a communicating portable device and the opening of an associated temporary session can be performed in different ways:

According to one embodiment, the temporary session data are stored on the access control server 400 which is connected to the private communication network 500 and is therefore accessible to the biometric activator 200. Thus, when the latter opens a temporary session, the data relating to this opening for the user 100 can be downloaded to the access control server. These data may include, in particular, an opening date, a duration, a termination date, etc. These data therefore represent the activation of the communicating portable device.

The access control server 400 may be provided to check these data and compare them with a current date in such a way as to terminate the temporary session when the time conditions are fulfilled.

According to another embodiment, the portable communicating device 101 is provided to be writable by the biometric activator. This is possible via, in particular, NFC technology. It then has a rewritable memory to which the biometric activator 200 can write data relating to the temporary session. These data may include, in particular, an opening date, a duration, a termination date, etc., and therefore represent the activation of the communicating portable device.

The biometric activator may write information which it has determined itself or which has been supplied by the access control server 400. It may be provided that the access control server 400 is systematically contacted by the biometric activator in order to allow the application of a centralized management of an access policy.

One variant of this embodiment can include or can consist of allowing the communication activator to transmit a message to the communicating portable device containing the information to be written to its memory, rather than writing it directly. The communicating portable device is then suitable for receiving and interpreting this message and for writing the information to its memory.

According to one embodiment, the biometric authentication is not performed by the biometric activator, but by the communicating portable device 101. The latter may in fact contain or be associated with a biometric sensor.

However, it may be provided that this device communicates with the biometric activator 200 in order to transmit the data originating from the biometric sensor (biometric signature, etc.) so that, if desired in this embodiment, the biometric sensor performs the opening of the temporary session, possibly following communication with the access control server 400.

According to one embodiment, the temporary session may also be closed by the occurrence of non-temporal events. In particular, an event of this type may be the breaking of the physical association between the user 100 and the communicating portable device 101.

For example, according to one embodiment, the communicating portable device 101 is implemented by means of a bracelet, belt or any other aspect fixed or connected to the user 100. This device may furthermore have means for detecting its opening and its closure. It may then determine that it is removed from the user 100 and may initiate its deactivation.

It may also determine its distancing from the user, for example by detecting an interruption of the contact with the skin of the user 100 through the breaking of an electrical contact. It may also detect the interruption of the signal corresponding to the heartbeats of the user 100 (cardiac pulsation). In this case also, it may then initiate its deactivation.

The deactivation may be initiated through the writing of appropriate status information to the memory of the communicating portable device which may be read by the equipment 300a . . . 300f by means of technologies such as RFID, NFC, etc. This is the case, in particular, when the temporary sessions are managed centrally by the access control server 400.

This writing can include or can consist of the deletion of some of the session data, or in their modification, according to practical implementations. For example, one datum may indicate in a binary manner whether the temporary session is open or not, and therefore whether the communicating portable device 101 is activated or not. According to another example, the termination date may be set to the current date, thus causing the temporary session to be terminated on the current date instead of the initially intended termination date.

Once the temporary session is open, the user 100 may attempt to access the different equipment of the site 10. This access is authorized following verification of the opening of the temporary session on the date of this access. The equipment for which an authorization is desired in this embodiment may represent only a part of the equipment available on the site.

The equipment to be secured may be associated with means for communicating with the communicating portable device. These means may be similar to those of the biometric activator and allow the implementation of a wireless communication between the equipment and the portable device, particularly in accordance with RFID, NFC, etc., technologies.

As previously stated, any type of equipment may be managed, operated or controlled within the scope of some embodiments. In the case of equipment such as a computer, mobile or fixed terminal, tablet, etc., this equipment may also be associated with an RFID or NFC reader of this type which, interworking with the method according to some embodiments and software means, can authorize or prevent access by the user 100.

This communication allows, in particular, the equipment 300 to read an identifier of the user 100 stored in the communicating portable device 101.

The equipment furthermore has means for determining an access authorization according to this identifier.

A plurality of implementations are possible.

According to a first embodiment, the temporary session data of the user 100 are stored on the access control server 400. In this case, the equipment 300 accesses this server via the private communication network 500 to which it is also connected. It may transmit a request containing the identifier of the user 100 and may receive in response the temporary session data corresponding to this identifier.

These data represent the activation of the communicating portable device. For example, if a temporary session start or end date is indicated among these data, this date is compared with a current date in order to determine whether the temporary session is actually open on the current date, corresponding to the access date, and whether the communicating portable device is activated or not.

The access authorization is obviously granted only if this communicating portable device is activated. If not, the user 100 cannot access the equipment 300.

According to one variant of this embodiment, the equipment may store all or most of the temporary session data locally. In this embodiment, the equipment may authorize or prevent access to the database containing this local information without having to contact the remote access control server 400. It is possible to provide updates of this local information by means of the remote server, periodically and/or during each new opening of a periodic session via the biometric activator 200.

According to a previously described third embodiment, the temporary session data are stored on the communicating portable device. In this case, the equipment 300 may then read these data and determine whether the temporary session is actually open and, as a consequence, authorize or prevent access by the user.

As previously, this involves checking whether the temporary session is open on the access request date. Consequently, the temporary session data stored on the device 101 must or should contain at least a date (start, end, etc.) in order to be able to compare it with the current date.

The biometric authentication is thus carried out once only in order to open a temporary session. As a result, only a limited number of biometric activators need to be provided on the site 10.

Furthermore, if it is indispensable or advisable to wear gloves, a mask, goggles, etc., on the site, the user does not have to remove them in order to perform a biometric authentication with each use of new equipment: the simple check on the status of his temporary session suffices and this check can be carried out with no action on the part of the user, via radiocommunication (RFIC, NFC, etc.).

This equipment access authorization mechanism is therefore immediate for users and is therefore compatible not only with industrial efficiency objectives, but also with emergency imperatives which may arise (access to a control panel in the event of an accident, etc.)

The method according to some embodiments is furthermore compatible with most of the conditions of a secure site 10, which may be an industrial site: such a site may be noisy, dirty, wet, filled with particles of dust or the like, in such a way that some authentication or security mechanisms, such as smartcards, etc., cannot be implemented. Some embodiments allows the equipment access authorization to be initiated in a contactless manner, even without the user removing the communicating portable device from his pocket, from his belt, etc., and can therefore be implemented in these difficult conditions.

The use of mechanisms for detecting the distancing of the user allows the session to be deactivated and therefore guards against thefts or loans between colleagues.

The use of temporary sessions during which the user can access the equipment using his communicating portable device guards against thefts or loans between colleagues.

It furthermore allows access policies to be defined across the entire site 10. It is thus possible to decide centrally that the temporary sessions are all terminated at a certain time. Temporary sessions terminating at different times according to teams, etc., can also be defined.

It is also possible to deactivate some communicating portable devices remotely by modifying the end time in the stored temporary session data, for example on the access control server 400. This may be useful in the case of an unforeseen event or, for example, in order to exclude a particular user who is behaving suspiciously, etc.

It is also possible to use the system according to some embodiments to allow access to equipment (servers, databases, network resources, etc.) of the site 10 from a communication terminal 700 which may be on the site or remote.

This terminal is typically a computer, Smartphone, tablet, etc. This terminal may be either mobile or fixed. It may be associated with means for communicating with the communicating portable device 101 and for authorizing or preventing access by the user to the equipment of the site 10.

The mechanisms implemented are similar to those previously described for access to the equipment 300, but they apply here to access, not to the terminal 700 itself but to the remote equipment 300 via the private communication network 500. This access may be referred to as “logical access” as opposed to physical access to equipment 300.

In the case of such logical access, a double authentication may be implemented, based not only on the checking of the opening of a temporary session for the user, but also on the authentication of the equipment 700. This ensures that the authentication of personnel is performed via equipment 700 itself authenticated during the same electronic transaction.

In order to authenticate the equipment, a signature of this equipment may be determined with each access, allowing its comparison with a reference signature stored in a database. The network can thus check which equipment is involved. This signature may be encrypted and designed in such a way as to be unfalsifiable.

This mechanism provides the facility to check that the equipment used is actually trusted equipment authorized on the site 10, and possibly that it is in fact associated with the user 100. In particular, this mechanism guards against the introduction of third-party equipment on the site 10, thus avoiding the security risks linked with this introduction.

This triple-factor authentication therefore checks not only “what I am” (the biometric aspects and the carrying of the portable device form a twin-factor authentication) and “what I own” (the equipment used by the user adds an additional factor to the authentication process).

If the terminal is located outside the site 10, this access is performed via both the private network 500 and a public communication network 600. This public network is typically the Internet network, allowing a user 100 to connect to some of the equipment 300 of the site 10 from home and/or from a different site of the company or body managing the site 10. According to some implementations, these two networks form part of the Internet network.

If the terminal is considered to be “trusted”, only the authorization to access this terminal may be provided: once authorized to access the terminal 700, the user 100 may access other equipment 300 directly without any other particular authentication processing. A terminal may be considered to be “trusted” if, for example, it is connected directly to the private communication network 500.

Otherwise, and particularly if the terminal 700 is connected to the private communication network via a public network 600, an additional mechanism may be provided. This additional mechanism may implement various authentication mechanisms. It may, for example, involve “weak” methods, such as those based on the MAC address of the terminal 700, on the IMEI (“International Mobile Equipment Identity”) or MEID (“Mobile Equipment Identifier”); or on “strong” methods, such as those based on the CHAP (“Challenge Handshake Authentication Protocol”) defined by the RFC 1994 of the IETF, or the Kerberos protocol, etc.

It is possible to determine in different ways whether a terminal 700 requesting an access authorization is a “trusted” terminal or not, and, in particular, whether it is connecting via a public network or not. One of these ways can include or can consist of drawing up an IP (“Internet Protocol”) addressing plan which suitably segregates the equipment connected to the private communication network 500 from the other equipment.

For example, the private communication network 500 may use 192.168.0.x IP addresses, where x allows the addressing of equipment, in particular, within the private network. If the private communication network includes a plurality of subnetworks, for example a fixed network and a Wifi network, the latter may use 192.168.1.x IP addresses.

Internet routing mechanisms ensure that the equipment located outside this private communication network cannot have addresses included within the address ranges defined in this way. It is therefore readily possible to determine whether equipment is connected directly to this private network or actually via a public network.

Some embodiments are obviously not limited to the examples and the FIGURE described and shown, but are susceptible to numerous variants accessible to the person of ordinary skill in the art.

1. A method for controlling access of a user to a set of equipment of a secure site from a communication terminal, the user being associated with a communicating portable device containing an identifier, theses method comprising the steps of:
opening of a temporary session by a biometric activator for the said user by means of a biometric authentication of theses user; and
authorization of the access by the user to equipment of the set, following verification and, on the other hand, of the authentication of said communication terminal through comparison between a signature determined at the time of access and a reference signature stored in a database within said secure site.

2. The method as claimed in claim 1, wherein the biometric authentication is carried out by means of an interaction with the biometric activator.

3. The method as claimed in claim 1, wherein the equipment, the communication terminal, the database and the biometric activator are connected via a private communication network.

4. The method as claimed in claim 1, wherein the data of the temporary session are stored on an access control server and wherein the equipment access the access control server to allow the access authorization of the user.

5. The method as claimed in claim 1, wherein the equipment stores the temporary session data of the user in a local memory for use during a next access authorization for the user.

6. The method as claimed in claim 1, wherein the communicating portable device communicates with the biometric activator and with the communication terminal via a wireless communication means, such as RFID, NFC, etc.

7. The method as claimed in claim 1, wherein the communicating portable device initiates the closure of the temporary session in the event of a break in the physical association between the user and the communicating portable device.

8. The method as claimed in claim 1, wherein the communicating portable device performs the biometric authentication by means of an internal sensor.

9. A system for controlling access of a user to a set of equipment of a secure site from a communication terminal, comprising:
a communicating portable device associated with the user and containing an identifier of the user,
a biometric activator allowing the opening of a temporary session for the user by means of a biometric authentication of the user, identified by the communicating portable device,
and wherein the equipment is suitable for being usable only in the event of authorization of the access by the user following verification, on the one hand, of the opening of the temporary session; the user being identified by the equipment by means of the communicating portable device and, on the other hand, of the authentication of the communication terminal through comparison between a signature determined at the time of access and a reference signature stored in a database within the secure site.

10. The system as claimed in claim 9, further comprising a private communication network connecting the biometric activator, the communication terminal, the database and the equipment, and an access control server also connected to the private communication network and storing the data of the temporary session.
